(19) United States
(12) Patent Application Publication
(10) Pub. No.: US 2009/0089281 A1
(43) Pub. Date: Apr. 2, 2009

(54) COMMUNITY INFORMATION FILTER

(76) Inventor: Marcus New, Vancouver (CA)

Correspondence Address: ANTOINETTE M. TEASE, P. O. BOX 51016, BILLINGS, MT, 59105, US

(21) Appl. No.: 12/237,360

(22) Filed: Sep. 24, 2008

(30) Foreign Application Priority Data
Sep. 27, 2007 (CA) 2638338

(51) Int. Cl. G06F 17/30

(52) U.S. Cl. 707/5; 707/E17.071

(57) ABSTRACT

A method and system to filter community information by rating members, rating their contributions, and evaluating the accuracy of predictions extracted from their contributions. These metrics can be a combination of subjective and objective factors. Subjective ratings can be weighted according to the ratings of those doing the rating.

### CROSS-REFERENCE TO RELATED APPLICATION

Pursuant to the Paris Convention, this application claims priority back to Canadian Patent Application No. CA2,638,338 filed on Sep. 27, 2007.

### BACKGROUND OF THE INVENTION

1. Field of the Invention

The present invention relates to filters for user-generated content.

2. Description of Related Art

The Internet hosts a multitude of communities that generate vast amounts of information on topics broad and specific, abstract and concrete. With so much information in so many knowledge domains from so many sources, it becomes exceedingly challenging for readers to filter the sage from the spin, the spam, the sham, the shill, the spite, the speculative, the simple, and the stupid.

What is needed is a better way to filter such user-generated information.

### SUMMARY OF THE INVENTION

The present invention is directed to this need. It teaches a way to filter information by regularly rating members of an information community, rating their contributions and evaluating the accuracy of their predictions. These metrics can be calculated as a combination of objective and subjective components. Ratings can be tuned by weighting subjective ratings according to the ratings of those doing the rating.

According to one aspect of the present invention, there is provided a method of filtering information exchanged within a community, comprising rating information contributed by a member according to an editorial component, a peer component and an objectively verifiable component.

The method might further include rating the member according to an editorial component, a peer component and an objectively verifiable component.

Rating according to a peer component could include weighting a rating assigned by a peer in accordance with the peer's own member rating.

At least one of the contribution rating and the member rating might beneficially include an array of ratings in a plurality of categories, such as topics of information exchanged within the community or categories of qualities, for example credibility, clarity and utility.

Rating according to an objectively verifiable component could involve: extracting a prediction from a contribution; accessing historical data probative to the prediction; and calculating an accuracy score for the prediction as a function of the prediction and probative historical data.

In this regard, extracting a prediction from a contribution might include extracting a structured prediction from a free-form contribution, parsing a contribution using natural language techniques to identify a subject, resolving synonymous subjects into a unique subject, or identifying relationships between a subject and related topics.

According to another aspect of the present invention, there is provided a system for filtering information maintained on a community information server, comprising means for rating information contributed by a member according to an editorial component, a peer component and an objectively verifiable component.

The system might further include means for rating the member according to an editorial component, a peer component and an objectively verifiable component.

Means for rating according to a peer component could includes means for weighting a rating assigned by a peer in accordance with the peer's own member rating.

At least one of the contribution rating and the member rating might beneficially include an array of ratings in a plurality of categories, such as topics of information exchanged within the community or categories of qualities, for example credibility, clarity and utility.

Means for rating according to an objectively verifiable component could include: means for extracting a prediction from a contribution; means for accessing historical data probative to the prediction; and means for calculating an accuracy score for the prediction as a function of the prediction and probative historical data.

In this regard, means for extracting a prediction from a contribution might means for extracting a structured prediction from a free-form contribution, means for parsing a contribution using natural language techniques to identify a subject, means for resolving synonymous subjects into a unique subject, or means for identifying relationships between a subject and related topics.

Further aspects and advantages of the present invention will become apparent upon considering the following drawings, description, and claims.

### DESCRIPTION OF THE INVENTION

The invention will be more fully illustrated by the following detailed description of non-limiting specific embodiments in conjunction with the accompanying drawing figures, which follow the conventions of the Unified Modeling Language, Version 2.

### 1. BRIEF DESCRIPTION OF THE DRAWINGS

FIG. 1 is a deployment diagram of one embodiment of a system implementing a community information filter in accordance with the teachings of the present invention;

FIG. 2 is a class diagram of embodiments of some of the classes manifested in the system of FIG. 1, namely a Member class, a Contribution class, a Prediction class, a HistoricalData class, and a Thesaurus association class;

FIG. 3 is an activity diagram of one embodiment of a method implementing a checkaccuracy( ) operation of the Prediction class;

FIG. 4 is an activity diagram of one embodiment of a method implementing a peerRateContribution( ) operation of the Contribution class;

FIG. 5 is an activity diagram of one embodiment of a method implementing a ratecontribution( ) operation of the Contribution class;

FIG. 6 is an activity diagram of one embodiment of a method implementing a peerRateMember( ) operation of the Member class; and

FIG. 7 is an activity diagram of one embodiment of a method implementing a RateMember( ) operation of the Member class.

### 2. DETAILED DESCRIPTION OF SPECIFIC EMBODIMENTS

### (a) Structure

The structure of various aspects of the invention will now be illustrated by explanation of specific, non-limiting, exemplary embodiments shown in the drawing figures and described in greater detail herein.

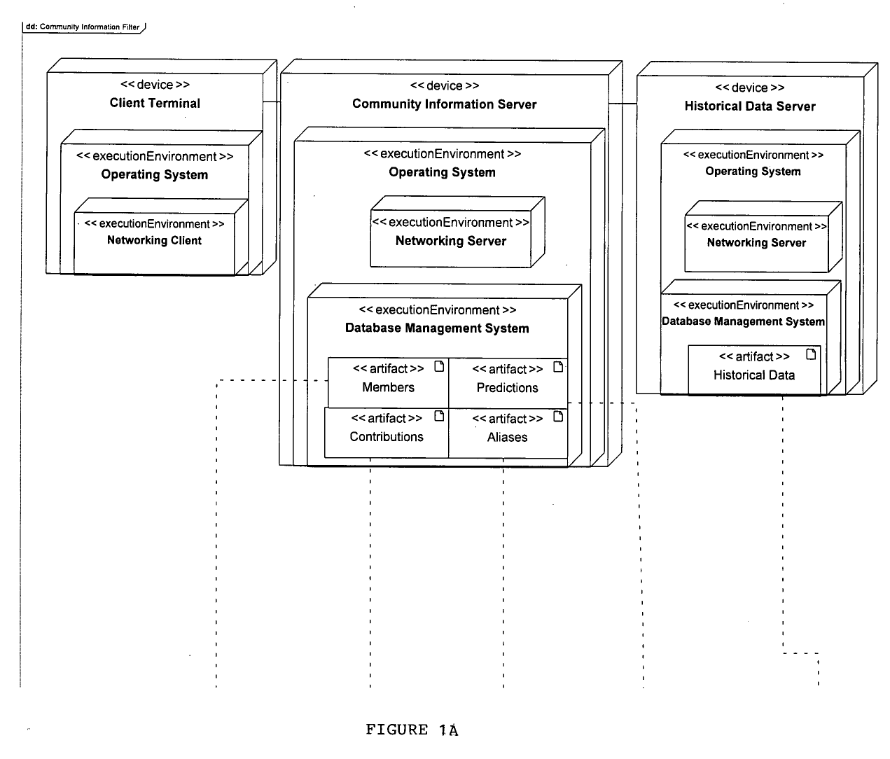

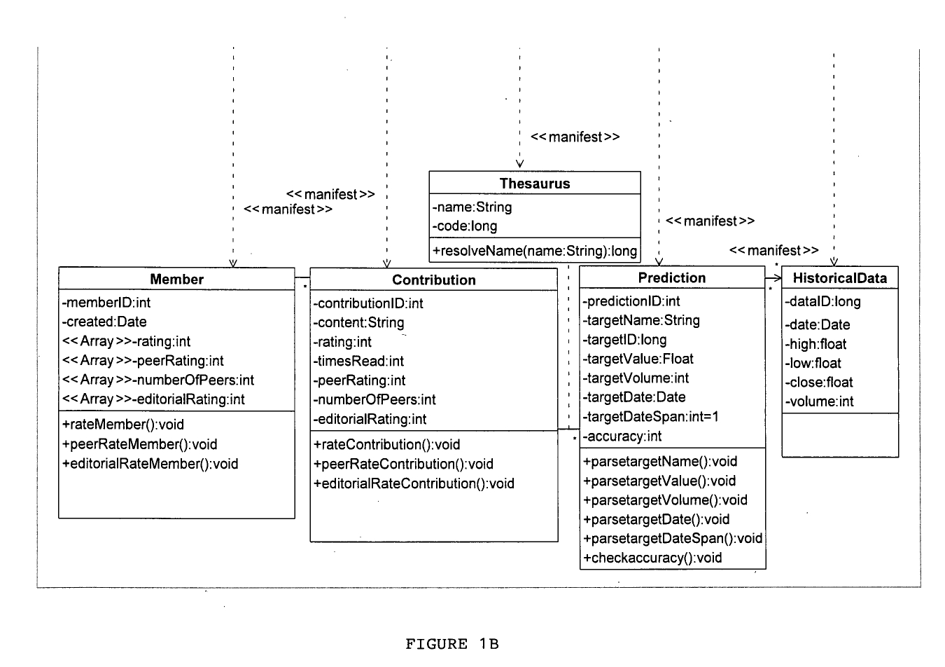

FIG. 1 shows a deployment of community information filter system according to one embodiment of the present invention.

The system includes a Community Information Server in communication with a Historical Data Server and a Client Terminal, for example, in communication over the Internet.

Each of the foregoing three nodes might be a single device or a network of devices. In this regard, the Community Information Server and the Historical Data Server would typically include a general-purpose programmable computer. The Client Terminal might also include a general-purpose programmable computer, but might alternatively include a mobile telephone or other wireless device.

Each of these three device nodes hosts an Operating System that provides an executionEnvironment supporting additional functionality and abstraction. In particular, the Operating Systems might support distributed execution among the nodes.

The Client Terminal's Operating System supports another executionEnvironment, namely a Networking Client that enables the Client Terminal to communicate over the Internet. In this regard, the Networking Client might support the operation of a communication application software, for example a web browser.

Similarly, the Operating Systems of the Community Information Server and the Historical Data Server support respective additional executionEnvironments, namely respective Networking Servers. The Networking Servers respectively enable the Community Information Server and the Historical Data Server to communicate over the Internet, including serving data and applications.

Thus in overview, a member of the community would use his Client Terminal to access the Community Information Server, for example by operating a web browser operating within the Networking Client exectutionEnvironment to communicate with a web server operating within the Networking Server exectutionEnvironment of the Community Information Server.

Additionally, the Operating Systems of the Community Information Server and the Historical Data Server support still further respective executionEnvironments, namely respective Database Management Systems that provide for the creation, storage, search, maintenance and destruction of structured information, for example objects, or more generally artifacts.

In this regard, the Community Information Server hosts databases of information artifacts about Members of the community, Contributions of information by Members to the community, objectively verifiable Predictions extracted from the Contributions, and Aliases for topics of the Predictions.

Similarly, the Historical Data Server hosts databases of probative Historical Data artfifacts in domains related to the Members, Contributions, Predictions and Aliases.

Those skilled in the art will appreciate that these databases might be distributed in another fashion. For example, the Community Information Server and the Historical Data Server might be combined. The arrangement illustrated recognizes that access to Historical Data is often purchased from one or more outside suppliers.

The Members, Contributions, Predictions, Historical Data and Aliases artifacts are manifestations of corresponding object classes that describe the community information system, namely Member, Contribution, Prediction, Historical Data classes and a Thesaurus association class.

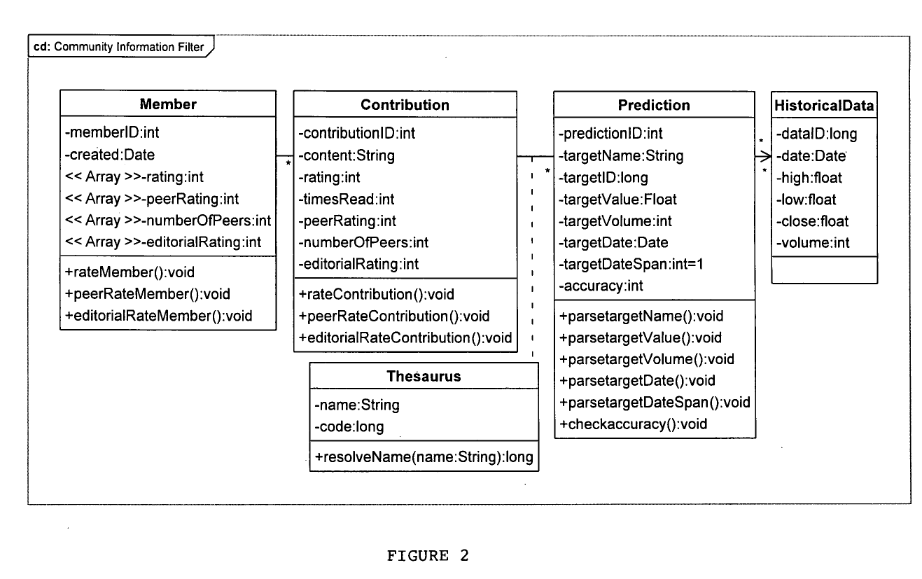

FIG. 2 is a class diagram of the foregoing classes, including some of their attributes, operations and associations. For clarity, constructors, destructors and accessors and other scaffolding attributes and operations have been omitted in general, except when they specifically aid the description.

The Member class provides attributes and operations for representing each of the living members of the community. In this regard, the Member class provides:
a unique memberID attribute for identifying a respective member,
a created attribute for designating the date a respective member joined the community, and
arrays of rating, peerRating, numberOfPeers, and editorialRating attributes, for representing in different ways a respective member's credibility rating in the community.

More particularly, the rating attribute represents an overall rating of the member. The peerRating attribute represents a rating of the member by his peers. The numberOfPeers attribute represents the number of peers rating the member. And the editoralRating attribute represents an official rating of the member by an administrator of the community or a delegate.

As provided in this embodiment, these latter four attributes may be arrayed into categories to provide for different credibility ratings for various topics of information, for example. In this regard, a member might be very credible with respect to baseball, but not credible whatsoever with respect to football or treasury bills. One such category might be reserved for an overall value, being the average or some other function of the values in all of the other categories. In a similar vein, a member might receive distinct ratings for each of credibility, clarity, and utility, for example, as well as or instead of a simple overall rating.

The Contribution class provides attributes and operations for representing each contribution of information provided by a member to the community. In this regard, the Contribution class provides:
a unique contributionID attribute for identifying a respective contribution,
a content attribute for representing the main substance of information being contributed, and
rating, timesRead, peerRating, numberOfPeers, and editorialRating attributes for representing in different ways a respective contribution's credibility rating in the community.

More particularly, the rating attribute represents an overall rating of the contribution. The timesRead attribute represents the number of times the contribution has been accessed, and might represent either the absolute number of accesses or the number of distinct members who have accessed the contribution. The peerRating attribute represents a rating of the contribution by peers in the community. The numberOfPeers attribute represents the number of peers rating the contribution. And the editorialRating attribute represents an official rating of the contribution by an administrator of the community or a delegate.

For simplicity and variety, these latter five attributes have not been arrayed into categories; however those skilled in the art will recognize that they could be. In a similar vein, a contribution might receive distinct ratings for each of credibility, clarity, and utility, for example, as well as or instead of a simple overall rating.

The Prediction class provides attributes and operations for representing verifiable predictions or hypothesis extracted from the more freeform content attribute of an associated Contribution object. In this sense, the word “prediction” is being used more broadly than meaning a hypothesis about a future event or state. The event or state that is the subject of the prediction might well reside in the past or the present. What remains for the future is the verification of the prediction, either because no probative data exists in the present or because such data must be first located and applied to evaluate the prediction, which latter scenario may take place exceedingly rapidly if probative data is already readily available to the community.

Those skilled in the art will recognize that the nature of the Prediction class depends to some extent on the domain of the predictions being represented. To a large extent, customizing the community for different domains of knowledge means customizing the Prediction class. Thus, for example, a community focussed on financial investments might implement a Prediction class that provides:
a unique predictionID attribute for identifying a respective prediction,
a targetName attribute for representing the subject of the prediction,
a targetID attribute both for uniquely identifying the subject of the prediction and for encoding its relationships to related topics and probative data,
a targetValue attribute for representing a first quantity prediction, for example a value of one unit of an investment on a particular date;
a targetVolume attribute for representing a second quantity prediction, for example a trading volume of units of the investment on a particular date;
a targetDate attribute for representing the effective date of the prediction;
a targetDateSpan attribute for representing a time range that includes the effective date for the purpose of bounding the set of probative data;
an accuracy attribute representing how closely the prediction matches actual data.

Thus for example, a Contribution object having a content attribute such as “ . . . I think Google's common stock will hit $1000 in the third quarter of 2008. . . . ” might initially correlate to a Prediction object having the following attributes:

| | |
|---|---|
| targetName = | “Google's common stock” |
| targetID = | (Undefined) |
| targetValue = | $1000 |
| targetVolume = | (Undefined) |
| targetDate = | Jul. 1, 2008 |
| targetDateSpan = | 3 months |
| accuracy = | (Undefined) |

Those skilled in the art will recognize that there are various ways to implement the relationship between the targetDate attribute and the targetDateSpan attribute that would accomplish similar ends. For example, the targetDate attribute might specify the middle of a span and the targetDateSpan attribute might specify equal spans before and after the effective date.

Those skilled in the art will also appreciate that the Prediction class may provide more dimensions for analysis than a particular Prediction object can extract from a particular Contribution object. Thus in the example above there Prodiction.targetVolume attribute remains undefined.

It will be noted from the example above that the Prediction.targetID attribute and the Prediction.accuracy attribute are both initial undefined as well. As will be described below, the Thesaurus association class and the HistoricalData class have roles in populating them.

The Thesaurus association class provides attributes and operations for resolving and categorizing the subject of a prediction as identified by the Prediction.targetName attribute. In this regard, the Thesaurus association class provides:
a name attribute for representing a common name—and likely not the only name—for typical topics of predictions in the domain; correlated to
a unique code attribute both for uniquely identifying the subject of a prediction and for encoding its relationships to related topics and probative data.

A Community Information Filter system would include a large number of Thesaurus objects for resolving and relating the topics of its knowledge domains.

Thus, for example, Thesaurus objects having name attributes that included strings such as “shares in Google”, “Google's common stock”, and “GOOG” would all have the same code attribute. In otherwords, those name attributes are all synonyms for the same subject, and hence the same code attribute.

In contrast, the string “Google” might resolve to either the company “Google Inc” or else that company's common stock. There might therefore be two Thesaurus objects having the same name attribute “Google” but having different code attributes. If the correct resolution could not be determined automatically by the context of use in the content attribute of the corresponding Contribution object, then the member submitting the contribution might be presented with an explicit choice for manual resolution.

Those skilled in the art will recognize that misspellings like “Goggle” might also be productively overcome through the creation of Thesaurus objects that include the same code attribute as the proper subject name.

Still more interesting is that a sufficiently long code attribute could be used to not only uniquely identify distinct subjects, but to also classify related topic. For example, a common share in Google is more generally an investment, a security, an equity, an American equity, a tech-sector equity, an American tech-sector equity, and so forth. Encoding such additional information in the code attribute can provide additional context for evaluating the accuracy of a particular prediction (e.g. is a particular investment performing differently from similar investments in its sector) and can group related predictions to uncover broader patterns, (e.g. the average accuracy of a member's predictions for tech-sector equities).

Finally, the code attribute can include sub-codes for keying into the Database Management System of the Historical Data Server to locate probative Historical Data objects.

The HistoricalData class provides attributes and operations for representing probative data for evaluating the accuracy of predictions. In this regard, the HistoricalData class provides:
a unique dataID attribute for identifying a respective historical data set, for example the trading history of a particular investment,
a date attribute for representing the measurement date a subset of the data set, and
one or more quantity attributes for representing the measured quantities of the data set, in this embodiment high, low, close and volume attributes representing the high, low and closing prices of an investment and the trading volume of the investment respectively.

Those skilled in the art will recognize the advantages of correlating the HistoricaIDatadataID attribute with the Thesaurus.code attribute, through sub-coding as described above or other encoding.

### (b) Operation

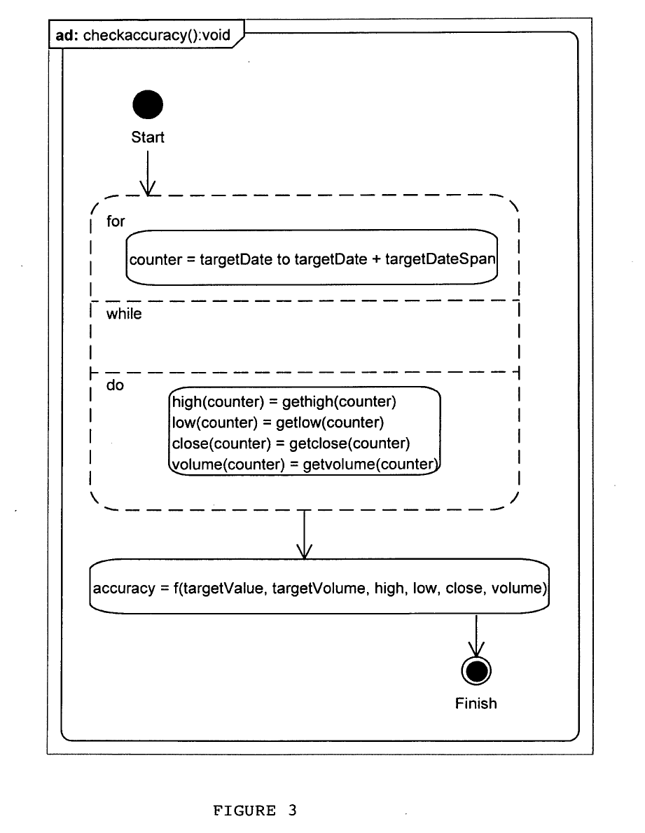

With reference now to FIGS. 1-2, and on occasion to FIGS. 3-7, the operation of these specific embodiments of the invention will now be described. First will be described the creation of a new membership in the community, then the contribution of information to the community, and then the extraction of a prediction from the contribution. Second will be described the evaluation of the accuracy of the prediction, the rating of the contribution and finally the rating of the member.

A person connects his Client Terminal to communicate with the Community Information Server over a communication channel. Typically, the person would direct a web browser operating in the Networking Client executionEnvironment to communicate over the Internet with a web server operating in the Networking Server executionEnvironment on the Community Information Server.

The person joins the information community by registering for membership. Using his web browser, he signifies his intention to register and provides sufficient data for the creation of a Member object administered by the Database Management System executionEnvironment on the Community Information Server More particularly he would provide contact and other profile data (not shown) and the Community Information Server would assign a unique memberID attribute, a created attribute representing the date of his registration and neutral initial rating attributes (rating, peerRating, numberOfPeers, and editorialRating).

Now a member, the person would have sufficient access via the Database Management System on the Community Information Server to contribute information. Again using his web browser, he signifies his intention to make a contribution and provides sufficient data for the creation of a Contribution object that will be associated with his Member object. More particularly, he would provide freeform information for encoding in the content attribute and the Community Information Server would assign a unique contributionID attribute, and neutral initial rating attributes (rating, timesRead, peerRating, numberOfPeers, and editorialRating).

When the member uses his web browser to signify that he wants to finalize his Contribution object, the Community Information Server automatically creates a corresponding Prediction object having a unique predictionID attribute and an indeterminate accuracy attribute.

A number of methods, namely parsetargetName( ), parsetValue( ), parsetargetVolume( ), parsetargetDate( ), and parsetargetDateSpan( ) are invoked and use natural language parsing techniques well-known in the art to extract prediction data from the Contribution.content attribute to be saved as targetName, targetValue, targetVolume, targetDate and targetDateSpan attributes of the Prediction object. Such parsing techniques use grammatical and contextual cues to extract subjects, predicates, objects, qualifiers and the like from sentences.

Expert knowledge of a specific community domain can be implemented in the parsing methods to refine parsing or resolve ambiguities. In the case of unresolvable ambiguities, the member submitting the contribution can be presented with explicit options to choose between subject concepts or topics as discussed above, for example does the word “Google” refer to a company, an investment, a technology or an activity.

Additionally, if any of the parsing methods detects more than one candidate for its respective attribute, then it can invoke the creation of an additional Prediction object to quantify the additional prediction espoused in the contribution.

Once it has identified a candidate targetName attribute, the parsetargetName( ) method additionally invokes the Thesaurus.resolveName( ) operation—a conventional search operation—to search for a corresponding Thesaurus.code value for storage as the Prediction.targetID attribute, thereby properly categorizing the Prediction object together with predictions about synonymous subjects and related topics and providing a key to access probative HistoricalData objects for evaluating the accuracy of the prediction.

So long as the accuracy attribute of a Prediction object is indeterminate, the checkaccuracy( ) operation is invoked periodically, perhaps after the date stored in the Prediction.targetDate attribute has passed or perhaps after an additional interval corresponding to that stored in the Prediction.targetDateSpan attribute. The operation might be invoked periodically afterward as well, in case new data changes the earlier result.

FIG. 3 illustrates one method implementing checkaccuracy( ) operation. The method extracts from the Prediction.targetID attribute a value corresponding to the HistoricalData.dataID attribute of the data set most probative for evaluating the subject of the prediction. For example, in the case of a prediction about the value of a common stock, the most probative data set would be the historical trading data for that common stock. The method then provides for retrieval of quantitative data from the data set within a particular historical period. In the case of this example, the retrieval of high price, low price, closing price and trading volume on each of the days between the targetDate of the prediction and the date at the end of the targetDateSpan.

The method calculates the accuracy of a prediction as a function of how closely the predicted values match the retrieved data. In this example, the accuracy is calculated as a function of targetvalue, the targetvolume, and the actual highs, lows, closes, and volumes. For example, a very lax accuracy function might demand that the targetvalue and the targetvolume lay at least once within the bounds of the actual data set retrieved. A more stringent accuracy function might demand that that occurred more often than not over the date span. Whatever the function, the result is stored as the Prediction.accuracy attribute.

Besides measuring the accuracy of predictions, the community also provides for the rating of corresponding contributions. Community administrators or their delegates, for example domain experts or senior community members, can simply assign an official editorial rating to a particular Contribution object via the Contribution.editorialRateContribution( ) operation.

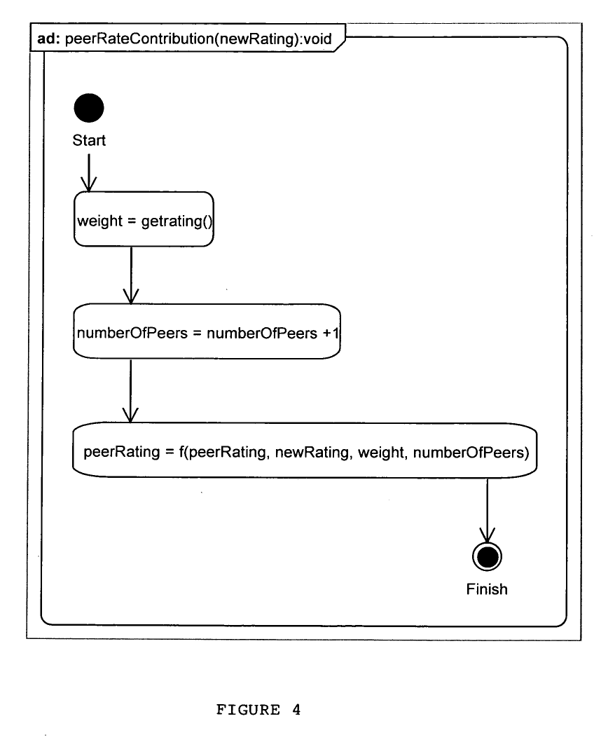

Additionally, community members can peer rate the contributions of other community members via the Contribution.peerRateContrbution( ) operation. FIG. 4 illustrates one method for implementing this operation. The rating member's own rating is retrieved, in order to weight the peer rating he is about to assign. In this way, ratings assigned by more highly-rated community members count more than ratings assigned by less highly-rated community members. The updated peer rating for a particular Contribution object is then a function of the current peer rating, the number of peers who have rated it, the newest peer rating and weight of the newest peer rating.

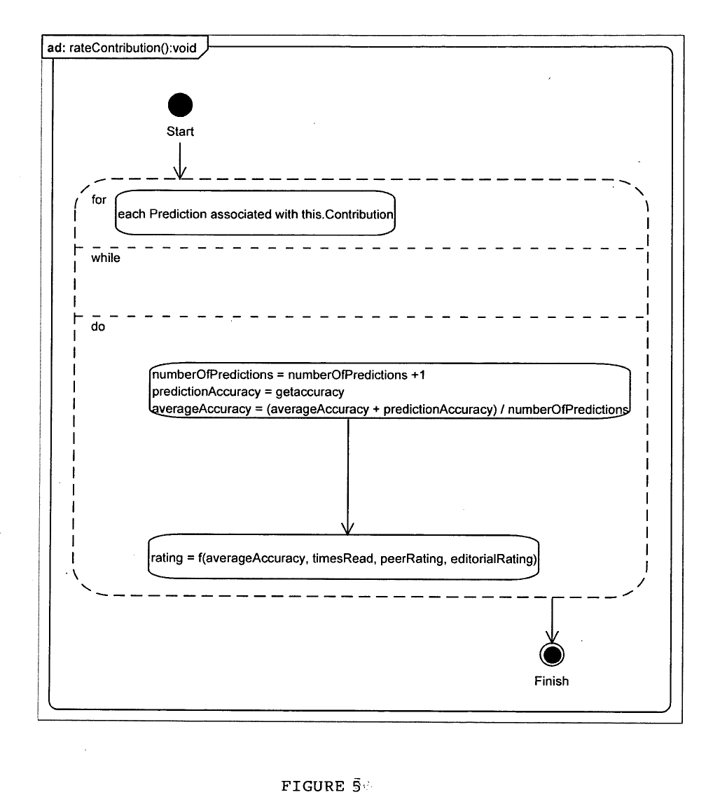

It will be noted that both of the foregoing ratings are subjective, being assigned by others in the community based upon their best judgement or other motivation. However, the community also provides for more objective rating via the Contribution.rateContribution( ) operation. FIG. 5 illustrates one method for implementing this operation. First, the accuracy of each Prediction object associated with a Contribution object is retrieved and an average accuracy is calculated. Then, the Contribution.rating attribute is calculated as a function of that average accuracy, the number of times the contribution has been read, the peer rating, and the editorial rating.

Those skilled in the art will appreciate the advantage of keeping this contribution rating current, either by invoking the Contribution.rateContribution( ) operation on a regular basis to account for recent changes in any of the underlying components or by including in the methods that update the underlying components an invocation of the Contribution.rateContribution( ) operation subsequent to their respective updates.

Besides evaluating the accuracy of predictions and assigning ratings to contributions, the community also provides for the rating of members. Community administrators or their delegates, for example domain experts or senior community members, can simply assign an official editorial rating to each Member object via the Member.editorialRateMember( ) operation.

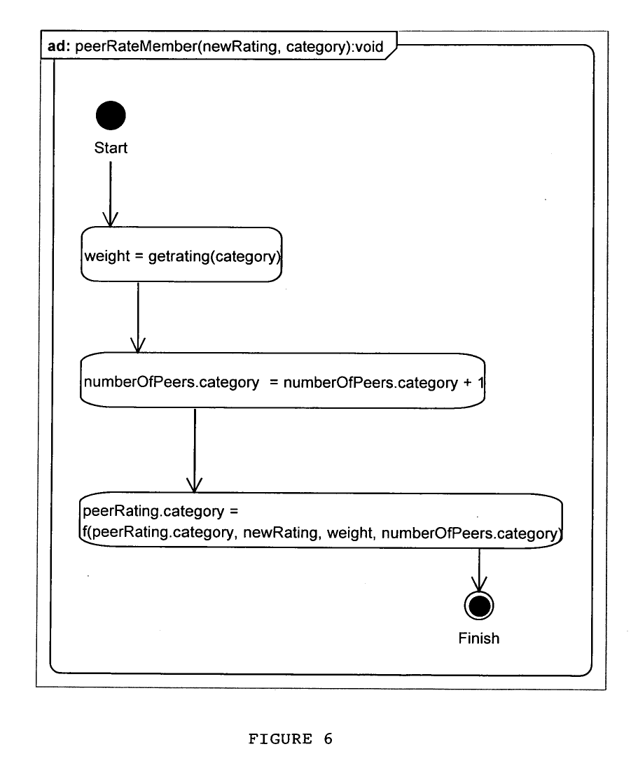

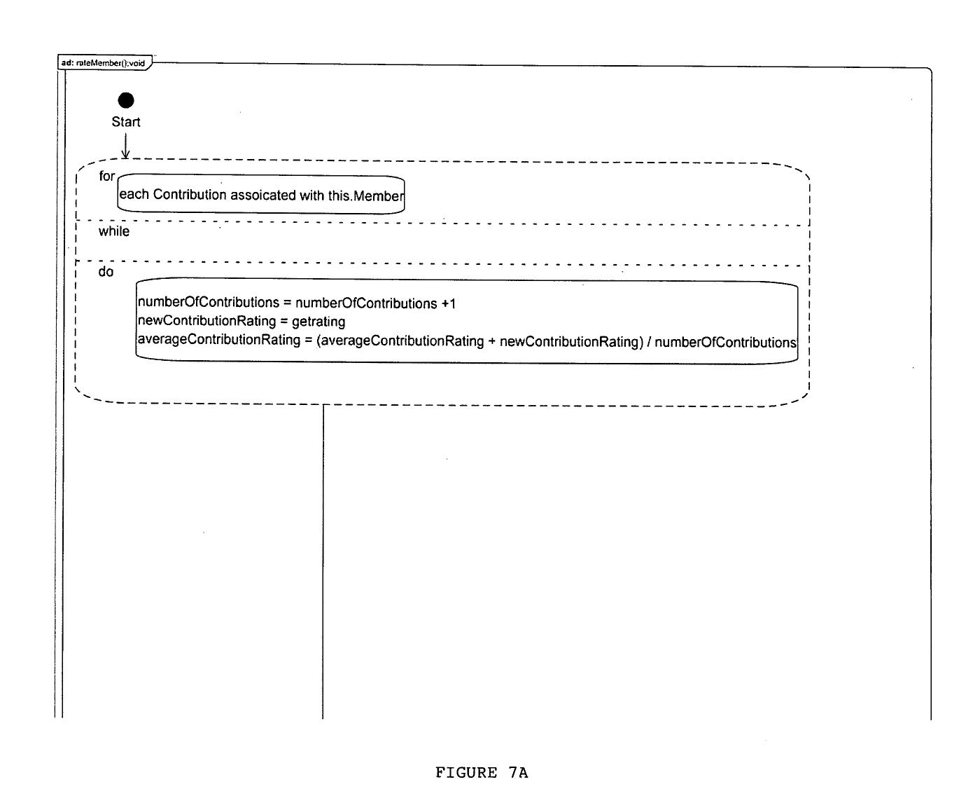

Additionally, community members can peer rate other community members via the Member.peerRateMember( ) operation. FIG. 6 illustrates one method for implementing this operation. The rating member's own rating in the category he wants to assign a rating is first retrieved, in order to weight the peer rating he is about to assign. In this way, ratings assigned by more highly-rated community members count more than ratings assigned by less highly-rated community members and for individual members, the ratings they assign in categories in which they are more highly-rated count more than ratings they assign in categories in which they themselves are less highly-rated. The updated peer rating for a particular Member object is then a function of its current peer rating, the number of peers who have rated it in the instant category, the newest peer rating and weight of the newest peer rating.

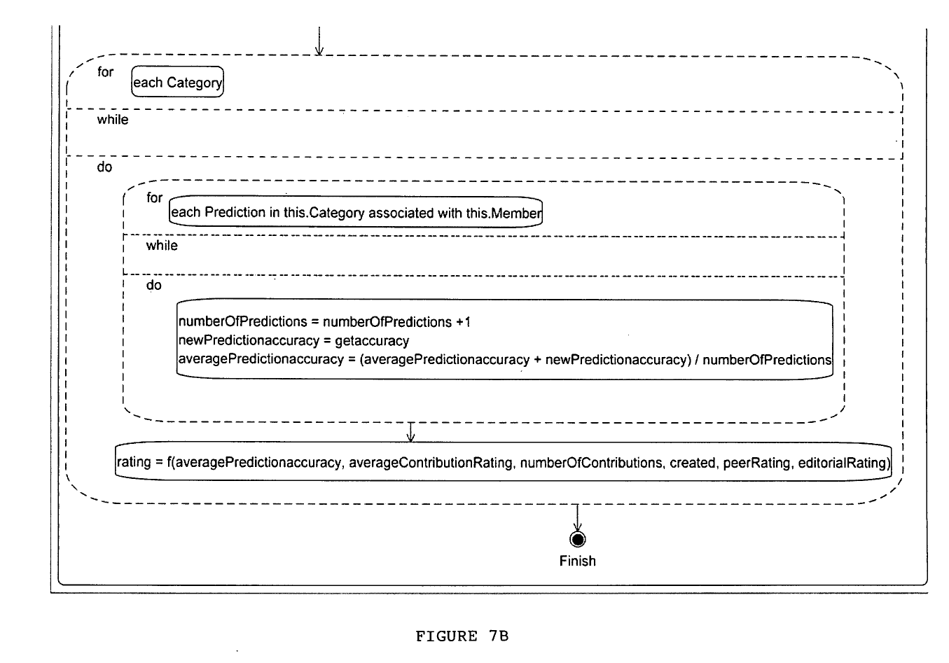

It will be noted that both of the foregoing ratings are subjective, being assigned by others in the community based upon their best judgement or other motivation. However, the community also provides for more objective rating via the Member.rateMember( ) operation. FIG. 7 illustrates one method for implementing this operation. First, the rating of each Contribution object associated with the particular Member object is retrieved and an average contribution rating is calculated. The total number of contributions associated with the Member object is also tallied. Then, for each category, the Prediction objects associated with the Member object are located, their respective accuracies retrieved, and an average accuracy for predictions in that category calculated. Finally, the Member.rating attribute for each category is calculated as a function of the average accuracy of predictions in that category, the average rating of the member's contributions, the total number of contributions by the member, the duration of the member's participation in the community, the peer rating of the member and the editorial rating of the member.

Those skilled in the art will appreciate the advantage of keeping this member rating current, either by invoking the Member.rateMember( ) operation on a regular basis to account for recent changes in any of the underlying components or by including in the methods that update the underlying components an invocation of the Member.rateMember( ) operation subsequent to their respective updates.

With this user-generated information now catalogued within a community, where members and their contributions are rated and their predictions are objectively tested for accuracy, it is more practical for a member or (even a non-member) of the community to locate and evaluate information on topics of interest. He might for example filter out low-rated members and contributions and less accurate predictions, so as to focus on only the best information the community has on the topic.

Alternatively, he might more freely compare various perspectives on a topic, while remaining mindful of metrics associated with each member, contribution and prediction. This approach might be useful for example when an investment issuer wants to monitor not only what is being said about it but also how such information is being received and rated. To support this informed browsing, the community might format the presentation of member data, contribution data and prediction data to include not only the ultimate rating or accuracy scores, but also some or all of the underlying components that yielded the scores as parameters in scoring functions. Such presentation would additionally permit the viewer to weigh the various components differently than the scoring functions, in case the view had particular biases, emphases or requirements.

In a particularly advanced embodiment of the invention, each member could tune custom scoring functions for evaluating the rating of members and contributions and the accuracy of predications. To avoid explosive growth in data storage requirements, such evaluations need not be stored globally or persistently across sessions, but could be recalculated on demand. Such tuning would help a brash member to find other brash but successful members and help a conservative member to find other conservative but successful members, for example, whereas a general filter might rate brashness or conservatism less favourably than might a particular member.

### (c) Description Summary

Thus, it will be seen from the foregoing embodiments and examples that there has been described a way to filter community information by rating members, rating their contributions, and evaluating the accuracy of predictions extracted from their contributions. These metrics can be a combination of subjective and objective components. Subjective ratings can be weighted according to the ratings of those doing the rating.

While specific embodiments of the invention have been described and illustrated, such embodiments should be considered illustrative of the invention only and not as limiting the invention as construed in accordance with the accompanying claims.

It will be understood by those skilled in the art that various changes, modifications and substitutions can be made to the foregoing embodiments without departing from the principle and scope of the invention expressed in the claims made herein. For example, although the embodiments describe a number of components being monitored and evaluated to yield accuracies and ratings, those skilled in the art will recognize that more, fewer or different components could be monitored or evaluated without so departing.

The embodiments describe community participation metrics such as duration of membership in the community and the number of contributions a member has made to the community; however, many others metrics may be relevant as well as or instead of these and would fit equally well with the teachings of the present invention. Examples of such additional metric for measuring community participation would include the number of subgroups a member has been accepted into, the number of other members who have designated the subject member as a friend, the number of members ignoring or blocking the subject member, and the number of members subscribing to the subject member's contributions.

Furthermore, systems within the scope and teaching of the invention could be architected with other than an object-oriented framework, for example a procedural or object-relational framework.

While the invention has been described as having particular application for communities exchanging financial information, those skilled in the art will recognize aspects of the invention have wider application, for example for other domains that lend themselves to subjective and objective evaluation.

What is claimed is:

1. A method of filtering information exchanged within a community, comprising rating information contributed by a member according to:
a) an editorial component;
b) a peer component; and
c) an objectively verifiable component.

2. A method as claimed in claim 1, further comprising rating the member according to:
a) an editorial component;
b) a peer component; and
c) an objectively verifiable component.

3. A method as claimed in claim 2, wherein rating according to a peer component includes weighting a rating assigned by a peer in accordance with the peer's own member rating.

4. A method as claimed in claim 2, wherein at least one of the contribution rating and the member rating includes an array of ratings in a plurality of categories.

5. A method as claimed in claim 4, wherein the categories correspond to topics of information exchanged within the community.

6. A method as claimed in claim 4, wherein the categories correspond to qualities.

7. A method as claimed in claim 6 wherein the qualities include at least one of:
a) credibility;
b) clarity; and
c) utility.

8. A method as claimed in claim 2, wherein rating according to an objectively verifiable component includes:
a) extracting a prediction from a contribution;
b) accessing historical data probative to the prediction; and
c) calculating an accuracy score for the prediction as a function of the prediction and probative historical data.

9. A method as claimed in claim 8, wherein extracting a prediction from a contribution includes extracting a structured prediction from a free-form contribution.

10. A method as claimed in claim 9, wherein extracting a prediction includes parsing a contribution using natural language techniques to identify a subject.

11. A method as claimed in claim 10, wherein identifying a subject includes resolving synonymous subjects into a unique subject.

12. A method as claimed in claim 11, wherein identifying a subject includes identifying relationships to related topics.

13. A system for filtering information maintained on a community information server, comprising means for rating information contributed by a member according to:
a) an editorial component;
b) a peer component; and
c) an objectively verifiable component.

14. A system as claimed in claim 13, further comprising means for rating the member according to:
a) an editorial component;
b) a peer component; and
c) an objectively verifiable component.

15. A system as claimed in claim 14, wherein the means for rating according to a peer component includes means for weighting a rating assigned by a peer in accordance with the peer's own member rating.

16. A system as claimed in claim 14, wherein at least one of the contribution rating and the member rating includes an array of ratings in a plurality of categories.

17. A system as claimed in claim 16, wherein the categories correspond to topics of information exchanged within the community.

18. A system as claimed in claim 16, wherein the categories correspond to qualities.

19. A system as claimed in claim 18 wherein the qualities include at least one of:
a) credibility;
b) clarity; and
c) utility.

20. A system as claimed in claim 14, wherein the means for rating according to an objectively verifiable component includes:
a) means for extracting a prediction from a contribution;
b) means for accessing historical data probative to the prediction; and
c) means for calculating an accuracy score for the prediction as a function of the prediction and probative historical data.

21. A system as claimed in claim 20, wherein the means for extracting a prediction from a contribution includes means for extracting a structured prediction from a free-form contribution.

22. A system as claimed in claim 21, wherein the means for extracting a prediction includes means for parsing a contribution using natural language techniques to identify a subject.

23. A system as claimed in claim 22, wherein the means for identifying a subject includes means for resolving synonymous subjects into a unique subject.

24. A system as claimed in claim 23, wherein the means for identifying a subject includes means for identifying relationships to related topics.
